(19) United States
(12) Patent Application Publication
(10) Pub. No.: US 2024/0036968 A1
(43) Pub. Date: Feb. 1, 2024

(54) MANAGING SERVICE CONFIGURATION ATTEMPTS FOR A HOST IN RESPONSE TO FAILURE

(71) Applicant: VMWARE, INC, Palo Alto, CA (US)

(72) Inventors: DIVYA TUMKUR PRAKASH, Bangalore (IN); RAHUL KUMAR SINGH, Bangalore (IN); ANIKET AVINASH SAKHARDANDE, Sunnyvale, CA (US); ALKESH SHAH, Sunnyvale, CA (US); NIHAL TIWARI, Sagar (IN)

(21) Appl. No.: 17/976,911

(22) Filed: Oct. 31, 2022

(30) Foreign Application Priority Data
Jul. 26, 2022 (IN) 202241042678

(51) Int. Cl. G06F 11/07

(52) U.S. Cl. CPC G06F 11/0793; G06F 11/076; G06F 11/0712

(57) ABSTRACT

Described herein are systems, methods, and software to manage configuration attempts for a service following a failure associated with the service according to an implementation. In one example, a management service monitors hosts in a computing environment and identifies a failure associated with a service on a first host. In response to identifying the failure, the management service identifies one or more criteria to initiate an attempt to configure the service based on the type of failure and initiates the attempt to configure the service when the one or more criteria are satisfied. Additional attempts can be initiated by the management service if the initial configuration attempt fails after a timeout interval.

### RELATED APPLICATIONS

Benefit is claimed under 35 U.S.C. 119(a)-(d) to Foreign Application Serial No. 202241042678 filed in India entitled “MANAGING SERVICE CONFIGURATION ATTEMPTS FOR A HOST IN RESPONSE TO FAILURE”, on Jul. 26, 2022, by VMware, Inc., which is herein incorporated in its entirety by reference for all purposes.

### BACKGROUND

In computing environments, host computing systems (hosts) support a platform for the execution of virtual machines. Hosts can include a hypervisor that abstracts the physical components of the host and provides abstracted hardware to the executing virtual machine, wherein the virtual machine may include its own operating system and software that uses the abstracted hardware. Hosts can further provide networking for the virtual machines that permits the virtual machines to communicate with each other and other computing nodes. The networking can include routing, switching, firewalls, or some other networking operation.

In some examples, the hosts and/or the services executing on the hosts to support the virtualization platform operations can fail. The failure can include a hardware failure, a power failure, a race condition failure, or some other software failure. In response to the failure, an administrator can diagnose the failure and initiate remediation operations to remedy the failure. However, as the number of services and hosts increase in a computing environment, the quantity of failures can be difficult and cumbersome for personnel to manage. Further, remedies to failures can be delayed as the personnel work to resolve other issues.

### SUMMARY

The technology described herein manages configuration attempts for service after a failure associated with the service. In one implementation, a method includes monitoring hosts to identify service failures at the hosts and identifying a failure associated with a service on a first host of the hosts. In response to the failure, the method further includes identifying a type of failure associated with the service and identifying one or more criteria to initiate an attempt to configure the service based on the type of failure. The method also provides for identifying when the one or more criteria are satisfied and initiating the attempt to configure the service when the one or more criteria are satisfied.

In some implementations, the method further provides for determining whether the attempt was successful and initiating one or more additional attempts based on the one or more criteria.

### BRIEF DESCRIPTION OF THE DRAWINGS

FIG. 1 illustrates a computing environment to manage configuration attempts for a service after a failure associated with the service according to an implementation.

FIG. 2 illustrates a monitoring operation to monitor failures associated with services in a computing environment according to an implementation.

FIG. 3 illustrates a remedy operation to manage configuration attempts for a service in response to a failure associated with the service according to an implementation.

FIG. 4 illustrates an operational scenario of managing a configuration attempt for a service according to an implementation.

FIG. 5 illustrates a flow diagram for apply multiple configuration attempts to a service according to an implementation.

FIG. 6 illustrates a management computing system to manage configuration attempts for a service after a failure associated with the service according to an implementation.

### DETAILED DESCRIPTION

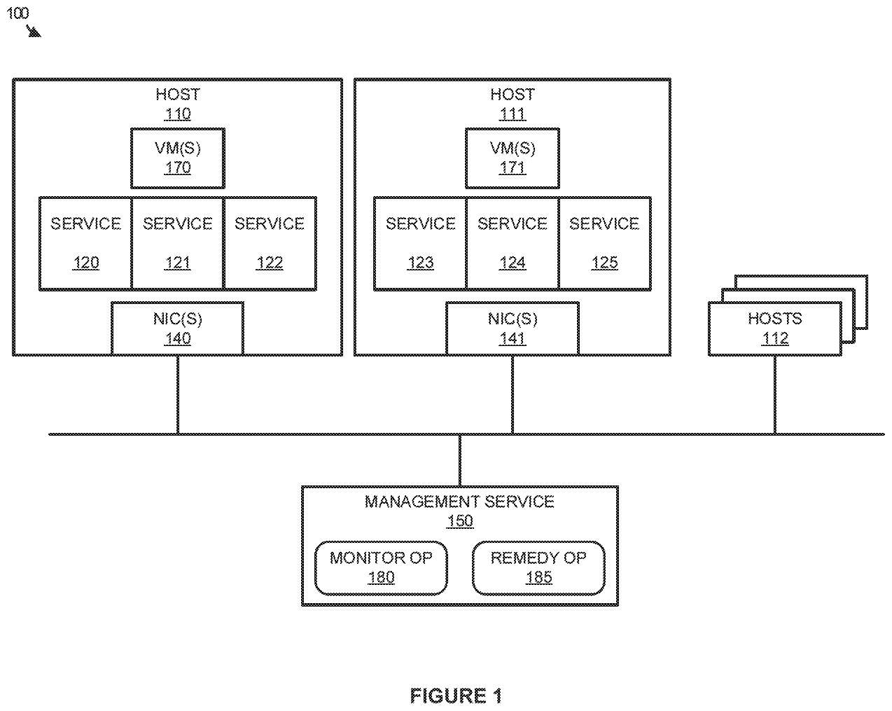

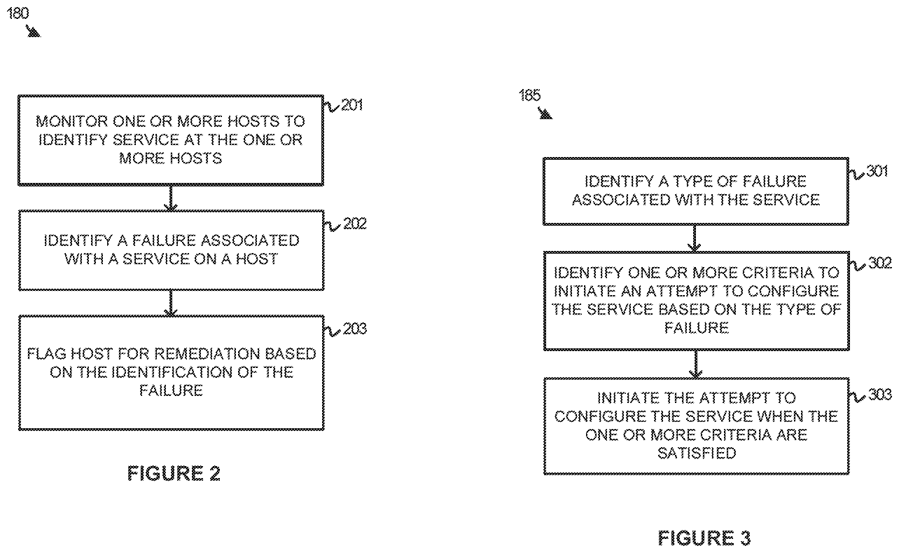

FIG. 1 illustrates a computing environment 100 to manage configuration attempts for a service after a failure associated with the service according to an implementation. Computing environment 100 includes hosts 110-112 and management service 150. Hosts 110-112 can represent physical computers with a storage system and at least one processor capable of supporting virtual machines 170-171. Hosts 110-111 further includes services 120-125 and network interfaces 140-141. Management service 150 can comprise one or more computers with a storage system and at least one processor capable of providing monitor operation 180 and remedy operation 185 further described in FIGS. 2 and 3. Although demonstrated as separate from hosts 110-112, management service 150 may reside wholly or partially on hosts 110-112. Additionally, while depicted without services or virtual machines, hosts 112 can include similar services and other virtual machines.

In computing environment 100, hosts 110-112 provide a virtualization platform for virtual machines, including virtual machines 170-171. To support the platform services 120-125 are included that can be used to support the initiation of virtual machines, support hardware abstraction for the virtual machines, assign and manage virtual disks and other resources for the virtual machines, provide virtual networking, including switching, routing, and encapsulation operations for the virtual machines or provide some other service for the virtual machines.

Services 120-125 can abstract the physical hardware of hosts 110-111 and provide the abstracted hardware to the virtual machines. The abstracted hardware can include processing resources, memory resources, networking resources, or some other resource. The resources provided can be dictated using at least one configuration file for each of the virtual machines. For example, a first virtual machine on host 110 can be provided with a first set of resources by services 120-122, while a second virtual machine on host 111 can be provided with a second set of resources by services 120-122.

In some examples, computing environment 100 can provide high availability that permits a second host to overcome a failure in association with a first host. The failure may comprise a software failure associated with the operating system or one or more services on the host, a failure of the hardware itself, a power failure, and update triggering a restart of the host, or some other failure. Management service 150 can monitor hosts 110-112 to identify a failure associated with the hosts and remediate the failure by reconfiguring the various failed services on the corresponding host. In some implementations, the management service 150 can communicate heartbeat or status messages to the hosts to determine a status of the hosts and services, wherein the status messages can be communicated periodically, in response to a request from management service 150, or at some other interval.

When a failure is identified, either through an express indication or through a lack of response, management service 150 can initiate remediation operations in association with the affected host and service. The remediation operations can include restarting one or more services in association with the failure, providing stateful information to the one or more services, providing a configuration (e.g., current firewall configuration), or performing some other operation in association with the hosts and services. In some examples, the remediation associated with an affected service can include identifying one or more criteria that can trigger the configuration of the service, wherein the one or more criteria can comprise a time interval, a notification from the host or another service, or some other criteria. For example, a failure of a service on a host may trigger a time for configuring the service on the host. At the expiration of the timer, management service 150 triggers a configuration of the service. In another example, a failure of a host can permit management service 150 to wait for the host to provide an indication of availability. Once available, management service 150 can attempt to configure one or more services on the host to support the desired operation. The attempts can be staggered in instances where multiple services require configuration to conserve resource usage associated with configuring each of the services.

In some implementations, a first attempt to configure a service can fail, wherein the failure of the attempt can occur when the host is unavailable, when another service is not available on the host, or based on some other factor. The determination whether an attempt is successful can be based on a notification from the service, by monitoring the execution of the service, or based on some other information. When a failure occurs, management service 150 can identify one or more second criteria to trigger a second attempt of configuring the service. The second criteria can be the same as for the first attempt or can be different than the criteria for the first attempt. In at least one example, the first criteria can comprise a time interval and the second criteria can comprise a second time interval. If a host fails, such as host 110, management service 150 can wait an interval prior to initiating a first attempt to configure a service, such as service 120. If the configuration fails, management service 150 can start a second timer and, after expiration of the timer, initiate a second attempt to configure the service. The attempts can be repeated indefinitely or until an attempt limit is exceeded.

FIG. 2 illustrates a monitoring operation 180 to monitor failures associated with services in a computing environment according to an implementation. The steps of operation 180 are referenced parenthetically in the paragraphs that follow with reference to systems and elements of computing environment 100 of FIG. 1. Monitor operation 180 can be stored on the storage system for management 150 and executed by the at least one processor of management service 150.

Monitor operation 180 includes monitoring (201) one or more hosts of a computing environment to identify service failures at the one or more hosts. The monitoring may include receiving status notifications from various hosts 110-112 of computing environment 100, exchanging status or heartbeat notifications with the hosts, receiving status notifications from a control system associated with computing environment 100, or some other monitoring mechanism. As an example, management service 150 can periodically communicate status requests to each host of hosts 110-112. The hosts can, in turn, indicate whether they are powered on and available, indicate whether one or more services are active and available, indicate any errors encountered by the services, or provide some other information.

While monitoring hosts 110-112, monitor operation 180 further includes identifying (202) a failure associated with a service on the host. The failure can include a hardware failure, an operating system failure, a power failure, a networking failure, an error reported from one or more services or some other failure. For example, management service 150 may communicate a status request to host 110 and fail to receive a response to the status request within a required period. Consequently, monitor operation 180 can flag (203) the host associated with the failure for remediation based on the failure. In flagging the host, management service 150 can perform various operations to restore the services on the affected host, including initializing the services, communicating stateful service information, or providing some other operation in association with the host. For example, if a power failure occurs with respect to host 110, management service 150 can identify the power failure and flag host 110 for remediation, wherein the remediation can be used to restore services 120-122 on host 110. An example remediation is provided below with respect to FIG. 3.

FIG. 3 illustrates a remedy operation 185 to manage configuration attempts for a service in response to a failure associated with the service according to an implementation. The steps of remedy operation 185 are referenced parenthetically in the paragraphs that follow with reference to systems and elements of computing environment 100 FIG. 1. Remedy operation 185 can be stored on the storage system for management 150 and executed by the at least one processor of management service 150.

After identifying a failure has occurred in association with a service on a host and the host is placed in remediation, remedy operation 185 identifies (301) a type of failure associated with the service. The type of failure can include a host related failure, including power failures, networking failures, an update to the host, or some other host related failure. The type of failure can also include software related failures, including the service failing to communicate a status notification, errors reported from other services, an operating system error, or some other type of failure. For example, if management service 150 communicated status checks to host 110 and host 110 failed to return a status update within a required period, management service 150 can determine that the host 110 itself is unavailable. In response to identifying the type of failure associated with the service, remedy operation 185 identifies (302) one or more criteria to initiate an attempt to configure the service based on the type of failure and initiates (303) the attempt to configure the service when the one or more criteria are satisfied.

The criteria for initiating the configuration of the service can include a time interval, a notification from a host indicating the host is available, a notification from one or more other services indicating that the one or more services are available, or some other criteria. In at least one implementation, the criteria can be different for each type of failure. For example, a host failure can be associated with one or more first criteria for initiating a configuration of a service, while a software failure or error associated with the service itself can be associated with one or more second criteria.

As an illustrative example, a failure can be identified in association with service 122 because of a power failure and restart of host 110. The criteria for an attempt to configure service 122 can include receiving a notification that host 110 is available, the expiration of a time interval or period following the identification of the failure, or some other criteria. Once the one or more criteria are satisfied, management service 150 can initiate an attempt to configure service 122. The attempt can include starting the service, communicating current rules or state information to the service, or providing some other operation in association with service 122.

In some implementations, the first attempt at configuring the service can fail. For example, when service 122 fails, management service 150 can initiate an attempt to communicate configuration information to the service and monitor to determine whether service 122 receives and implements the configuration information (e.g., communicates an acknowledge message to management service 150). If the first attempt fails, management service 150 can monitor for second criteria, which can be the same as the first criteria in some examples, and when the second criteria are satisfied, initiates a second attempt to configure the service. The attempts can be repeated indefinitely or repeated until attempt limit exceeded. The attempt limit can be associated with the type of failure or can be the same for all types of failures. Once the limit is exceeded, management service 150 can generate a notification, wherein the notification can be communicated to an administrative client as an email, pop-up, or some other notification. The notification can include information about the failure, including the host, the service identifier, or some other information associated with the failure. In addition to or in place of communicating the notification, management service 150 can store a log of the failed configuration.

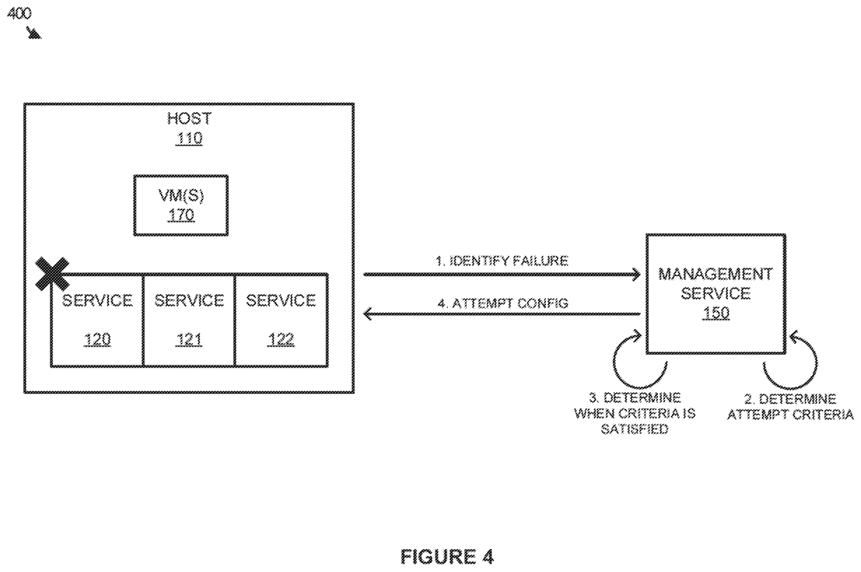

FIG. 4 illustrates an operational scenario 400 of managing a configuration attempt for a service according to an implementation. Operational scenario 400 includes host 110 and management service 150 from FIG. 1. Host 110 includes services 120-122 and virtual machines 170. The remaining elements from computing environment 100 have been omitted for clarity.

In operational scenario 400, management service 150 monitors hosts in the computing environment to identify a failure associated with a service on the one or more hosts. The failure can comprise a hardware failure associated with the host, network connectivity issues associated with the host, an update occurring on the host, software failure associated with one or more services or the operating system of the host, or some other failure. In some implementations, management service 150 can obtain status information from hosts in the computing environment, wherein the status can correspond to the overall host or individual services on the host. The status information can be provided in response to a request from management service 150 or can be provided periodically from hosts 110-112. Here, management service 150 identifies a failure at step one associated with service 120. The failure can be indicated by host 110 or can be identified based on host 110 not providing a status update within a required period.

In response to identifying the failure associated with service 120, management service 150 determines, at step two, one or more criteria to attempt a configuration to remediate the issue with service 120. The criteria may comprise a time interval (e.g., two minutes from the discovery of the failure), can comprise a notification from one or more other services or the host itself, or can comprise some other criteria. In some implementations, management service 150 will determine the criteria for the attempt based on the type of issue encountered. For example, a failure of another codependent service may require first criteria to trigger the configuration of service 120, while the failure of an entire host can require second criteria to trigger the configuration of service 120. For example, with a failure of a codependent service, management service 150 may attempt to configure service 120 when a notification is received that the codependent service is active. In contrast, when a failure is associated with host 110, management service 150 can wait for a notification indicating that host 110 is available or can wait a time interval prior to initiating the attempt to configure service 120.

After identifying the one or more criteria for service 120, management service 150 determines when the one or more criteria are satisfied at step 3. Once the one or more criteria are satisfied in association with service 120, management service attempts to configure service 120 at step 4. In attempting to configure service 120, management service 150 can initiate the execution of service 120, communicate state information or other configuration information, or configure some other information in association with service 120. In a high availability system, the state information for service 120 can be communicated from another host that provides failover support for service 120.

Although demonstrated with a single attempt of configuring service 120 in operational scenario 500, some configuration operations can require multiple attempts. For example, management service 150 can initiate a first attempt to configure service 120 and monitor service 120 to determine whether the first attempt was successful. If the first attempt was not successful, management service 150 can identify one or more second criteria associated with a second attempt. The one or more second criteria can be the same as the one or more criteria for the first attempt or can be different than the one or more criteria for the first attempt. For example, the one or more criteria for the first attempt may comprise an indication that host 110 is available to support service 120. In response to the indication, management service 150 can initiate an attempt to configure service 120 on host 110. Management service 150 then monitors service 120 and/or host 110 to determine whether the attempt was successful. The monitoring may include a notification from host 110 indicating the execution of service, a state report associated with service 120 matching an expected state, or some other indication whether the attempt was successful. If no indication is received or the notification indicates the failure of the first attempt, management service 150 can identify one or more second criteria, wherein the second criteria can include a time interval for management service 150 to wait prior to initiating the second attempt. One the time interval expires, management service 150 can generate a second attempt. The attempts can be repeated indefinitely or until an attempt limit is exceeded. The attempt limit can be the same for all services or can be unique to the type of service. Additionally, the attempt limit can be the same for all types of failures or can be different for different types of failures.

In some examples, when the failure occurs in association with service 120, failures can also be identified with one or more related services to service 120. For example, service 120 can be dependent on service 121, wherein service 121 fails or encounters an error in providing the requisite operations. Management service 150 can identify the dependencies between the services, and initiate remediation operations in association with service 121. The remediation operations can include restarting service 121, providing configuration or state information to service 121, or some other remediation. Management service 150 monitors for the completion in the configuration of service 121 and initiates the attempt to configure service 120 in response to completing the remediation of service 121. In examples where the remediation of service 121 fails (exceeds an attempt limit), management service 150 may generate a notification for an administrator that indicates the failure of configuring service 121. The notification may further indicate one or more other services that have also failed, information about the host, information about the remediation attempts, or some other information about the failed remediation of service 121.

Although demonstrated as a failure of a single service in the example of FIG. 4, some failures can cause a failure associated with multiple services. For example, the failure of host 110 can cause services 120-122 to be reconfigured or restarted when host 110 is again available. Management service 150 can stager the configuration of the different services to ensure there are no race conditions or to limit the resources required to configure the different services. For example, if services 120-122 fail, management service 150 can stagger the attempts of configuring services 120-122 to limit resource usage required to configure the different services.

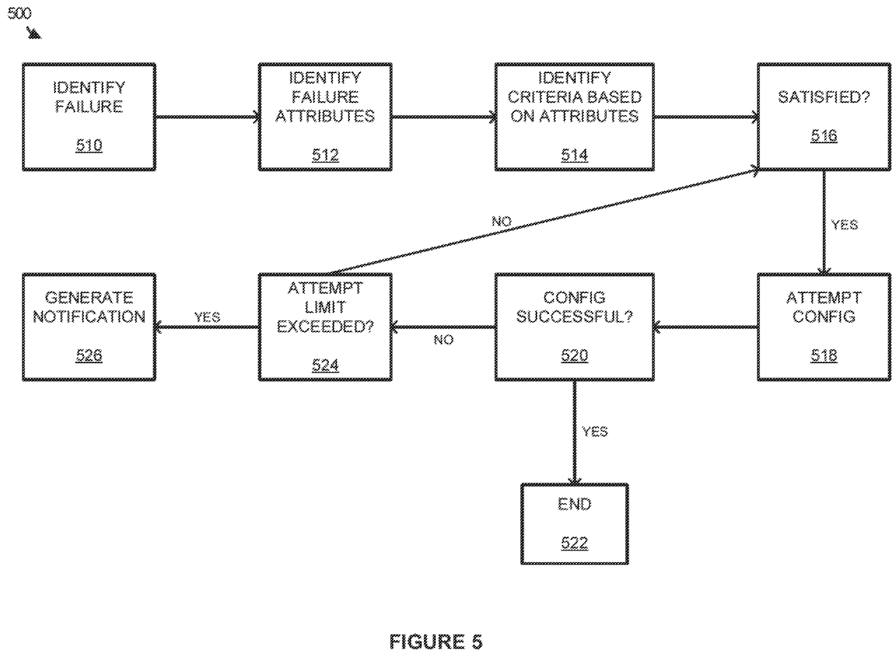

FIG. 5 illustrates a flow diagram 500 for apply multiple configuration attempts to a service according to an implementation. The steps in flow diagram 500 are referenced parenthetically in the paragraphs that follow. Flow diagram 500 is representative of an operation that can be performed by a management service, such as management service 150 of FIG. 1.

In flow diagram 500, the management service identifies (510) a failure of a service on a host. In response to identifying the failure, the management service can identify (512) attributes associated with the failure. The attributes may include the type of service that failed, the type of failure (e.g., hardware or software), or some other attribute associated with the failure. From the attributes, the management service identifies (514) one or more criteria to trigger an attempt to configure the failed service. The one or more criteria may include a time interval, a notification that a host and/or another service is available, a notification that the service is available to be configured (i.e., executing on the host), or some other criteria. For example, after a host failure, the host may communicate a notification to the management service indicating the host is available for the service.

Once the one or more criteria are identified, the management service determines (516) when the one or more criteria are satisfied. When the one or more criteria are satisfied, the management service attempts (518) a configuration of the service. The attempt can include starting the service, providing state information to the service (e.g., current resource allocations, flows, or some other information). Once the attempt is made, the management service determines (520) whether the configuration was successful. The determination can be based on a notification from the service that the service is active, based on another service indicating the service is active, monitoring the status or execution of the service, or based on some other factor. If it is determined that the configuration was successful, then the management service ends (522) further operations in association with the service. The management service can continue to update other services on the host until the host completes its remediation.

When it is determined that the configuration was not successful, the management service determines (524) whether an attempt limit is exceeded in association with the service. The attempt limit can be defined for all services or can be dynamic based on the type of service. Similarly, the attempt limit can be defined based on the type of failure encountered, wherein a first attempt limit can be associated with a first type of failure, while a second attempt limit can be associated with a second type of failure. For example, a hardware failure associated with an entire host can be associated with a different attempt limit than software failure associated with one or more services or the operating system of the host. When the attempt limit is not exceeded, the management service will determine whether one or more criteria are satisfied to initiate a second attempt to configure the service. The one or more criteria associated with the second attempt can be the same as the first attempt or can be different from the first attempt. The one or more criteria for the second attempt can be a time interval from the first attempt, a status notification associated with the host or one or more services on the host, or some other criteria. When the one or more criteria for the second attempt are satisfied, the management service can initiate the second attempt. Attempts can be repeated for the service until the configuration of the service is completed or successful, or the attempt limit is exceeded.

When the attempt limit is exceeded, the management service generates (526) a notification indicating the failure of the configuration. The notification can indicate the service that failed, the host associated with the service, any other services associated with the affected service, or some other information. In some implementations, the notification is stored as a log entry that can be accessed by an administrator from the management service. In other implementations, the notification can be communicated to an administrative client, wherein the information can be used by the administrator of the computing environment to remediate the failure associated with the service.

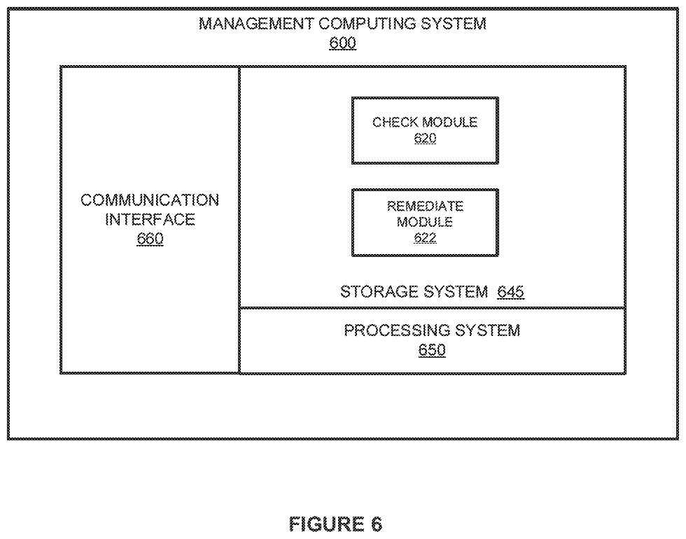

FIG. 6 illustrates a management computing system 600 to manage configuration attempts for a service after a failure associated with the service according to an implementation. Management computing system 600 is representative of any computing system or systems with which the various operational architectures, processes, scenarios, and sequences disclosed herein for management service can be implemented. Management computing system 600 is an example of management service 130 and 430, although other examples may exist. Management computing system 600 includes storage system 645, processing system 650, and communication interface 660. Processing system 650 is operatively linked to communication interface 660 and storage system 645. Communication interface 660 may be communicatively linked to storage system 645 in some implementations. Management computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with hosts of a computing environment. Communication interface 660 can also communicate with one or more other control systems, client systems, or outside computers.

Processing system 650 comprises microprocessor and other circuitry that retrieves and executes operating software from storage system 645. Storage system 645 may include volatile and nonvolatile, removable, and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises check module 620 and remediate module 622. The operating software on storage system 645 may further include an operating system, utilities, drivers, network interfaces, applications, or some other type of software. When read and executed by processing system 650 the operating software on storage system 645 directs management computing system 600 to operate as a management service described herein in FIG. 1-5.

In at least one implementation, check module 620 directs processing system 650 to monitor hosts in a computing environment to identify service failures at the hosts. The monitoring may include receiving status information from the hosts using heartbeat messages or other periodic status checks. The status information can indicate the status of the host itself (i.e., active, unavailable, and the like) and can further provide information about the status of the services on the host. The services can be used to provide virtualization platform for virtual machines, including allocating and managing physical resources for the virtual machines, providing networking for the virtual machines, assigning virtual disks to the virtual machines, or providing some other service in association with the virtualization platform.

While monitoring the hosts of the computing environment, check module 620 directs processing system 650 to identify a failure associated with a service on a first host in the computing environment. The failure can comprise a hardware or software failure associated with the service itself or the host of the service. In response to identifying the failure, the host is assigned for remediation, wherein remediation may include reconfiguring the service, reconfiguring one or more additional services on the host, or some other action to place the host in a healthy state.

In at least one example, remediate module 622 directs processing system 650 to identify one or more criteria to initiate an attempt to configure the service. The criteria can be the same for all types of failures or can be different based on the type of failure. For example, a failure associated with a power failure of the first host may require different criteria than a race condition failure associated with the service and at least one other service. The race condition can cause an issue when a first service relies on a second service but is initiated or misconfigured prior to the second service. The one or more criteria can comprise a time interval required prior to configuring the service, can comprise the completion of one or more remediation operations associated with one or more other services, can comprise a notification associated with a restart of a host or operating system, or can comprise some other criteria. As an illustrative example, a service can fail on a first host and based on the type of failure, the management service can identify a time interval or timer that can trigger an attempt to configure the failed service.

Once the one or more criteria are satisfied for an attempt, remediate module 622 directs processing system 650 to initiate an attempt to configure the service. In at least one example, the failed service can correspond or rely on one or more other services. In this example, the management service can initiate operations to configure or restart the one or more other services, and initiate configuration of the failed service in response to identifying the one or more other services are active. The management service can identify the status of the one or more other services via monitoring the execution of the one or more other services, receiving a notification from the one or more services, or via some other process.

When the attempt to configure the service is successful, remediate module 622 directs processing system 650 to remove the service and/or host from the remediation process. For example, when all services are operational on the host, the host can be removed from the remediation process. The host can remain in the remediation process until all services are available on the host. In implementations where the service configuration was not successful, the remediate module 622 directs processing system 650 to identify when second criteria are met for a second attempt to configure the service. The second criteria can be the same as the criteria to trigger the first attempt (e.g., expiration of a period), or can be different criteria, wherein the criteria can include an interval, a notification associated with another host or service, or some other criteria. The attempts can be repeated for the service based on the same or different criteria until the service is successfully configured or until an attempt limit is reached in association with the service.

In some implementations, an attempt limit can be the same for all services encountering a failure. In other implementations, the attempt limit can be based on the type of failure, the type of service, or some other factor. For example, when a host fails, a limit attempt can reflect the failure of the entire host. Once the limit is exceeded, remediate module 622 directs processing system 650 to stop the attempts of configuring the service. Additionally, a notification can be generated that includes information about the failure, including the failure type, the identity of the host and/or service, or some other information.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
monitoring hosts to identify service failures at the hosts;
identifying a failure associated with a service on a first host of the hosts;
identifying a type of failure associated with the service;
identifying one or more criteria to initiate an attempt to configure the service based on the type of failure; and
initiating the attempt to configure the service when the one or more criteria are satisfied.

2. The method of claim 1, wherein the type of failure comprises a host failure, and wherein one or more criteria comprise a notification received from first host indicating the first host is available.

3. The method of claim 1, wherein monitoring the hosts to identify service failures at the hosts comprises exchanging status messages at intervals.

4. The method of claim 1 further comprising:
determining when the attempt to configure the service is unsuccessful;
when the attempt is unsuccessful:
identifying one or more second criteria to initiate a second attempt to configure the service; and
initiating the second attempt to configure the service when the one or more second criteria are satisfied.

5. The method of claim 1 further comprising:
determining that the attempt to configure the service is unsuccessful; and
in response to determining that the attempt is unsuccessful, initiating one or more additional attempts to configure the service based on the one or more criteria.

6. The method of claim 5 further comprising:
identifying that the attempt and the one or more additional attempts exceed an attempt limit; and
in response to exceeding the attempt limit, generating a notification indicative of a failure to configure the service.

7. The method of claim 5, wherein the one or more criteria comprises a time interval.

8. The method of claim 1 further comprising:
initiating remediation operations in association with one or more other services associated with the service; and
wherein the one or more criteria comprises a notification from the first host indicating a completion of the remediation operations.

9. The method of claim 1 further comprising:
identifying a failure associated with one or more second services on the first host; and
initiating an attempt to configure the one or more second services on the first host, wherein the attempt to configure the one or more second services is staggered in relation to initiating the attempt to configure the service.

10. A computing apparatus comprising:
a storage system;
at least one processor coupled to the storage system; and
program instructions stored on the storage system that, when executed by the at least one processor, direct the computing apparatus to:
monitor hosts to identify service failures at the hosts;
identify a failure associated with a service on a first host of the hosts;
identify a type of failure associated with the service;
identify one or more criteria to initiate an attempt to configure the service based on the type of failure; and
initiate the attempt to configure the service when the one or more criteria are satisfied.

11. The computing apparatus of claim 10, wherein the type of failure comprises a host failure, and wherein one or more criteria comprise a notification received from first host indicating the first host is available.

12. The computing apparatus of claim 10, wherein monitoring the hosts to identify service failures at the hosts comprises exchanging status messages at intervals.

13. The computing apparatus of claim 10, wherein the program instructions further direct the computing apparatus to:
determine when the attempt to configure the service is unsuccessful;
when the attempt is unsuccessful:
identify one or more second criteria to initiate a second attempt to configure the service; and
initiate the second attempt to configure the service when the one or more second criteria are satisfied.

14. The computing apparatus of claim 10, wherein the program instructions further direct the computing apparatus to:
determine that the attempt to configure the service is unsuccessful; and
in response to determining that the attempt is unsuccessful, initiate one or more additional attempts to configure the service based on the one or more criteria.

15. The computing apparatus of claim 14, wherein the program instructions further direct the computing apparatus to:
identify that the attempt and the one or more additional attempts exceed an attempt limit; and
in response to exceeding the attempt limit, generate a notification indicative of a failure to configure the service.

16. The computing apparatus of claim 14, wherein the one or more criteria comprises a time interval.

17. The computing apparatus of claim 10, wherein the program instructions further direct the computing apparatus to:
initiate remediation operations in association with one or more other services associated with the service; and
wherein the one or more criteria comprises a notification from the first host indicating the completion of the remediation operations.

18. The computing apparatus of claim 10, wherein the program instructions further direct the computing apparatus to:
identify a failure associated with one or more second services on the first host; and
initiate one or more attempt to configure the one or more second services on the first host, wherein the attempt to configure the one or more second services is staggered in relation to initiating the attempt to configure the service.

19. A system comprising:
a plurality of hosts; and
a management computing system coupled to the plurality of hosts and configured to:
monitor hosts to identify service failures at the hosts;
identify a failure associated with a service on a first host of the hosts;
identify a type of failure associated with the service;
identify one or more criteria to initiate an attempt to configure the service based on the type of failure;
initiate the attempt to configure the service when the one or more criteria are satisfied;
determine when the attempt to configure the service is unsuccessful;
when the attempt is unsuccessful:
identify one or more second criteria to initiate a second attempt to configure the service; and
initiate the second attempt to configure the service when the one or more second criteria are satisfied.

20. The system of claim 19, wherein the one or more criteria and the one or more second criteria comprise time intervals.
